(19) United States
(12) Patent Application Publication
(10) Pub. No.: US 2021/0023649 A1
(43) Pub. Date: Jan. 28, 2021

(54) FRICTION WELDING APPARATUS AND METHOD OF OPERATING THE SAME

(71) Applicant: KAWASAKI JUKOGYO KABUSHIKI KAISHA, Kobe-shi, Hyogo (JP)

(72) Inventors: Yoshitaka MURAMATSU, Akashi-shi (JP); Ryoji OHASHI, Kobe-shi (JP); Naoki TAKEOKA, Kakogawa-shi (JP); Takuya FUKUDA, Kakogawa-shi (JP)

(73) Assignee: KAWASAKI JUKOGYO KABUSHIKI KAISHA, Kobe-shi, Hyogo (JP)

(21) Appl. No.: 16/982,644

(22) PCT Filed: Mar. 15, 2019
(86) PCT No.: PCT/JP2019/010910

§ 371 Date: Sep. 21, 2020

(30) Foreign Application Priority Data
Mar. 19, 2018 (JP) 2018-051288

(51) Int. Cl. B23K 20/12; B29C 65/06; B23K 20/227

(52) U.S. Cl. CPC B23K 20/121; B23K 2103/04; B23K 20/2275; B29C 65/06

(57) ABSTRACT

A friction welding apparatus is provided, which includes a tool, a rotary driver, a linear driver, and a control device. The control device controls the linear driver and the rotary driver so that the tool is rotated while a tip-end part thereof is pressed against a to-be-joined part of a to-be-joined object to increase a temperature of the to-be-joined part at or above an A1 transformation point, the tip-end part of the tool reaches a given first position so that a softened second member sticks into a softened first member, and the tool is drawn out from the to-be-joined part while the tool is rotated.

### TECHNICAL FIELD

The present disclosure relates to a friction welding apparatus and a method of operating the same.

### BACKGROUND ART

A friction welding method in which a plurality of steel members are joined using frictional heat is known (e.g., see Patent Document 1). In the friction welding method disclosed in Patent Document 1, two sheets of steel plates are joined by pressing a rotary tool against a to-be-joined part while rotating the rotary tool to raise the temperature of the to-be-joined part at or above an A3 transformation point, then letting the to-be-joined part be cooled at or below an A1 transformation point, and drawing out the rotary tool from the to-be-joined part in the state at or below the A1 transformation point.

### REFERENCE DOCUMENT OF CONVENTIONAL ART

### Patent Document

[Patent Document 1] JP2008-073694A

### DESCRIPTION OF THE DISCLOSURE

### Problem to be Solved by the Disclosure

However, the friction welding method disclosed in Patent Document 1 is a method of joining the two sheets of steel plates, but it does not take joining of different types of plate members into consideration, for example, joining between a plate material made of aluminum and a plate material made of steel, and therefore, there is still room for an improvement.

The present disclosure is made in view of solving the problem, and one purpose thereof is to provide a friction welding apparatus and a method of operating the same, capable of increasing a joining strength, when joining a plurality of members made of different materials by using frictional heat.

### Summary of the Disclosure

In order to solve the conventional problem described above, a friction welding apparatus according to the present disclosure is a friction welding apparatus configured to join a to-be-joined object having a first member and a second member by softening with frictional heat. The friction welding apparatus includes a tool formed cylindrically, and rotatable about an axis thereof and reciprocatable in a direction along the axis, a rotary driver configured to rotate the tool about the axis, a linear driver configured to reciprocate the tool along the axis, and a control device. The first member is disposed opposing to the tool and is made of a different type of material from the second member, and the second member is made of steel. The control device controls the linear driver and the rotary driver so that (A) the tool is rotated about the axis while a tip-end part of the tool is pressed against a to-be-joined part of the to-be-joined object to increase a temperature of the to-be-joined part at or above an A1 transformation point, (B) while the temperature of the to-be-joined part is maintained at or above the A1 transformation point, the tip-end part of the tool reaches a given first position set beforehand so that the softened second member sticks into the softened first member, and (C) the tool is drawn out from the to-be-joined part, while the temperature of the to-be-joined part is maintained at or above the A1 transformation point and the tool is rotated.

Accordingly, a joining strength can be increased even if the plurality of members made of different materials are joined using frictional heat.

Moreover, a method for operating a friction welding apparatus according to the present disclosure is a method for operating a friction welding apparatus configured to join a to-be-joined object having a first member and a second member by softening with frictional heat. The friction welding apparatus includes a tool formed cylindrically, and rotatable about an axis thereof and reciprocatable in a direction along the axis, a rotary driver configured to rotate the tool about the axis, and a linear driver configured to reciprocate the tool along the axis. The first member is disposed opposing to the tool and is made of a different type of material from the second member, and the second member is made of steel. The method includes operating the linear driver and the rotary driver so that (A) the tool is rotated about the axis while a tip-end part of the tool is pressed against a to-be-joined part of the to-be-joined object to increase a temperature of the to-be-joined part at or above an A1 transformation point, (B) while the temperature of the to-be-joined part is maintained at or above the A1 transformation point, the tip-end part of the tool reaches a given first position set beforehand so that the softened second member sticks into the softened first member, and (C) the tool is drawn out from the to-be-joined part, while the temperature of the to-be-joined part is maintained at or above the A1 transformation point and the tool is rotated.

Accordingly, the joining strength can be increased even if the plurality of members made of different materials are joined using frictional heat.

The above-described purpose, other purposes, features, and advantages of the present disclosure will become clear from detailed description of preferred modes described below with reference to the accompanying drawings.

### Effect of the Disclosure

According to the friction welding apparatus and the method of operating the same of the present disclosure, the joining strength can be increased even if the plurality of members made of different materials are joined using frictional heat.

### BRIEF DESCRIPTION OF DRAWINGS

FIG. 1 is a schematic view illustrating an outline configuration of a friction welding apparatus according to Embodiment 1.

FIG. 2 is a flowchart illustrating one example of operation of the friction welding apparatus according to Embodiment 1.

FIG. 3 is a schematic view illustrating a substantial part of the friction welding apparatus according to Embodiment 1.

FIG. 4 is a schematic view illustrating a substantial part of one example of a friction welding apparatus in Modification 1.

FIG. 5 is a schematic view illustrating a substantial part of one example of a friction welding apparatus in Modification 2.

FIG. 6 is a schematic view illustrating an outline configuration of a friction welding apparatus according to Embodiment 2.

FIG. 7 is a flowchart illustrating one example of operation of the friction welding apparatus according to Embodiment 2.

### MODES FOR CARRYING OUT THE DISCLOSURE

Hereinafter, desirable embodiments of the present disclosure are described with reference to the drawings. Note that, below, the same reference characters are assigned to the same or corresponding components throughout the drawings to omit redundant description. Moreover, throughout the drawings, components which are needed to describe the present disclosure are selectively illustrated, and illustration of other components may be omitted. Further, the present disclosure is not limited to the following embodiments.

### Embodiment 1

A friction welding apparatus according to Embodiment 1 is a friction welding apparatus in which a to-be-joined object having a first member and a second member is softened and joined by frictional heat. The apparatus includes a tool formed cylindrically, and rotatable about an axis thereof and reciprocatable in a direction along the axis, a rotary driver which rotates the tool about the axis, a linear driver which reciprocates the tool along the axis, and a control device. The first member is disposed opposing to the tool, and is made of a different type of material from the second member, and the second member is made of steel. The control device controls the linear driver and the rotary driver so that (A) the tool is rotated about the axis while a tip-end part of the tool is pressed against a to-be-joined part of the to-be-joined object to raise the temperature of the to-be-joined part at or above an A1 transformation point, (B) in a state where the temperature of the to-be-joined part is maintained at or above the A1 transformation point, the tip-end part of the tool reaches a given first position set beforehand so that the softened second member sticks into the softened first member, and (C) the tool is drawn out from the to-be-joined part while the temperature of the to-be-joined part is maintained at or above the A1 transformation point, and the tool is rotated.

Alternatively, in the friction welding apparatus according to Embodiment 1, the control device may control the linear driver and the rotary driver, during (A), so that the temperature of the to-be-joined part becomes at or above an A3 transformation point.

Alternatively, in the friction welding apparatus according to Embodiment 1, the control device may control the linear driver and the rotary driver, during (B), so that the temperature of the to-be-joined part is maintained at or above the A3 transformation point.

Alternatively, in the friction welding apparatus according to Embodiment 1, the control device may control the linear driver and the rotary driver, during (C), so that the temperature of the to-be-joined part is maintained at or above the A3 transformation point.

Alternatively, in the friction welding apparatus according to Embodiment 1, the first member may be made of at least one material of aluminum, thermoplastic resin, and fiber-reinforced plastic.

Alternatively, the friction welding apparatus according to Embodiment 1 may further include a temperature detector which detects the temperature of the to-be-joined part, and the control device may determine whether the temperature of the to-be-joined part is at or above the A1 transformation point based on the temperature detected by the temperature detector.

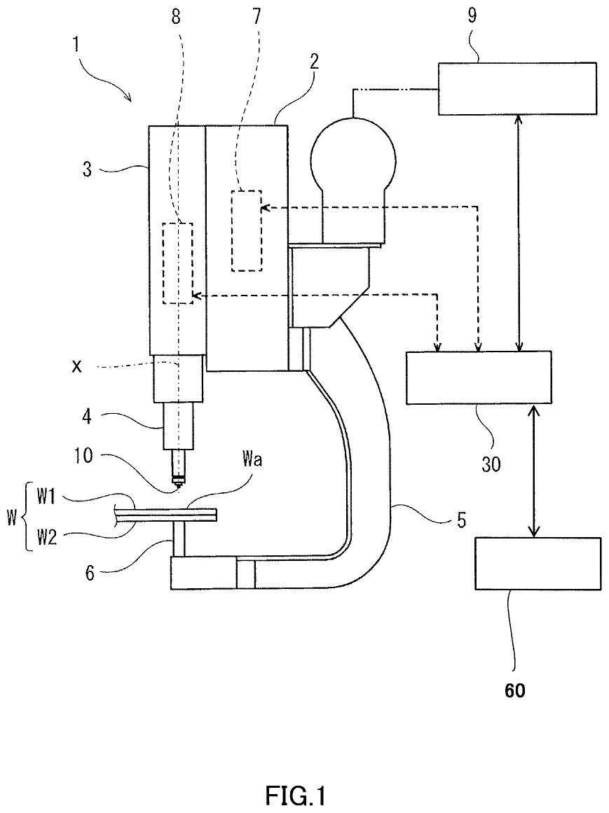

Hereinafter, one example of the friction welding apparatus according to Embodiment 1 is described in detail with reference to FIGS. 1 to 3.

### Configuration of Friction Welding Apparatus

FIG. 1 is a schematic view illustrating an outline configuration of the friction welding apparatus according to Embodiment 1.

As illustrated in FIG. 1, a friction welding apparatus 1 according to Embodiment 1 includes a tool 10, a base body 2, a movable body 3, a tool holder 4, a linear driver 7, a rotary driver 8, a temperature detector 60, and a control device 30. The friction welding apparatus 1 softens a to-be-joined part Wa of a to-be-joined object W by frictional heat to join the to-be-joined object W.

The base body 2 is detachably attached to a tip-end part of a robotic arm 9. The movable body 3 is attached to the base body 2 movably in a direction of an axis X of the tool holder 4. The tool holder 4 is provided to a tip-end part of the movable body 3.

The tool holder 4 is rotatable about its axis X, and is movable in the direction of the axis X integrally with the movable body 3. The tool 10 is detachably provided to a tip-end part of the tool holder 4. Note that the tool 10 may have a known configuration in the field of friction stir welding.

Moreover, the linear driver 7 is disposed inside the base body 2. The linear driver 7 moves the movable body 3 (tool 10) linearly in the direction of the axis X. For example, the linear driver 7 may be an electric motor (servomotor), and a ball-screw mechanism or a linear-guide mechanism, or an air cylinder. Moreover, a position detector which detects the position of the tip-end part of the tool 10 may be disposed at the linear driver 7. For example, the position detector may be an encoder.

The rotary driver 8 is disposed inside the movable body 3. The rotary driver 8 rotates the tool holder 4 and the tool 10 about the axis X. For example, the rotary driver 8 may be an electric motor (servomotor).

Further, a curved frame 5 formed in a substantially C-shape (a substantially L-shape) is fixed to the base body 2. The curved frame 5 is formed so that its tip-end part opposes to the tool 10. Moreover, a support 6 is provided to the tip-end part of the curved frame 5. The support 6 supports the to-be-joined object W. That is, in Embodiment 1, the base body 2, the movable body 3, the tool holder 4, the curved frame 5, and the support 6 are comprised of a C-shaped gun (C-shaped frame).

In Embodiment 1, the to-be-joined object W is comprised of a plate-like first member W1 and a plate-like second member W2. The first member W1 may be made of at least one material among metallic material (e.g., aluminum), thermoplastic resin (e.g., polyamide), and fiber-reinforced plastic (e.g., carbon fiber reinforced plastic). The second member W2 may be made of a different metallic material (e.g., steel) from that of the first member W1.

Although in Embodiment 1 the to-be-joined object W is comprised of the plate-like first member W1 and the plate-like second member W2, the shape of the to-be-joined object W (the first member W1 and the second member W2) is arbitrary, without being limited to the above configuration, and, for example, may be a rectangular parallelepiped shape, or may be formed in an arc shape.

The temperature detector 60 detects the temperature of the to-be-joined part Wa of the to-be-joined object W and outputs the detected temperature to the control device 30. The temperature detector 60 may be any kind of detector, as long as it can detect the temperature of the to-be-joined part Wa of the to-be-joined object W, and, for example, it may be an infrared sensor, or may be a thermocouple disposed inside the support 6.

The control device 30 includes a processor, such as a microprocessor and a CPU, and a memory, such as a ROM and a RAM (none of them is illustrated). The memory stores information, such as a basic program and various fixed data. The processor controls various operations of the linear driver 7, the rotary driver 8, and the robotic aim 9 by reading and executing software, such as the basic program stored in the memory.

Note that the control device 30 may be comprised of a sole control device 30 which carries out a centralized control, or may be comprised of a plurality of control devices 30 which collaboratively carry out a distributed control. Moreover, the control device 30 may be comprised of a microcomputer, or may be comprised of a MPU, a PLC (Programmable Logic Controller), or a logic circuit, etc.

### Operation of Friction Welding Apparatus (Method of Operating Friction Welding Apparatus)

Next, a method of operating the friction welding apparatus 1 according to Embodiment 1 is described with reference to FIGS. 1 to 3. Note that the following operation is executed by the processor of the control device 30 reading the program stored in the memory.

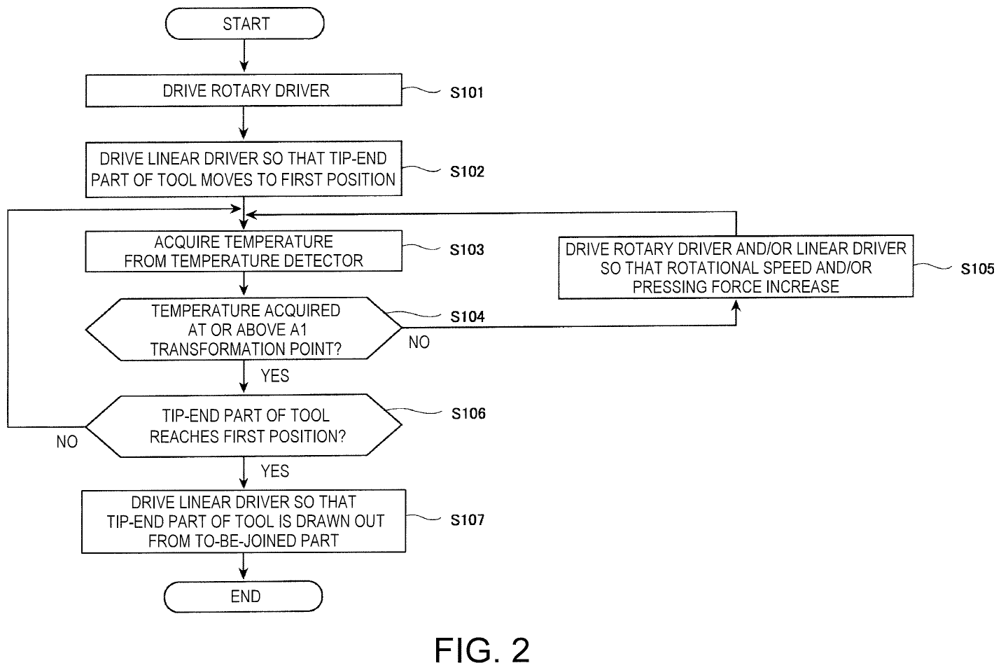

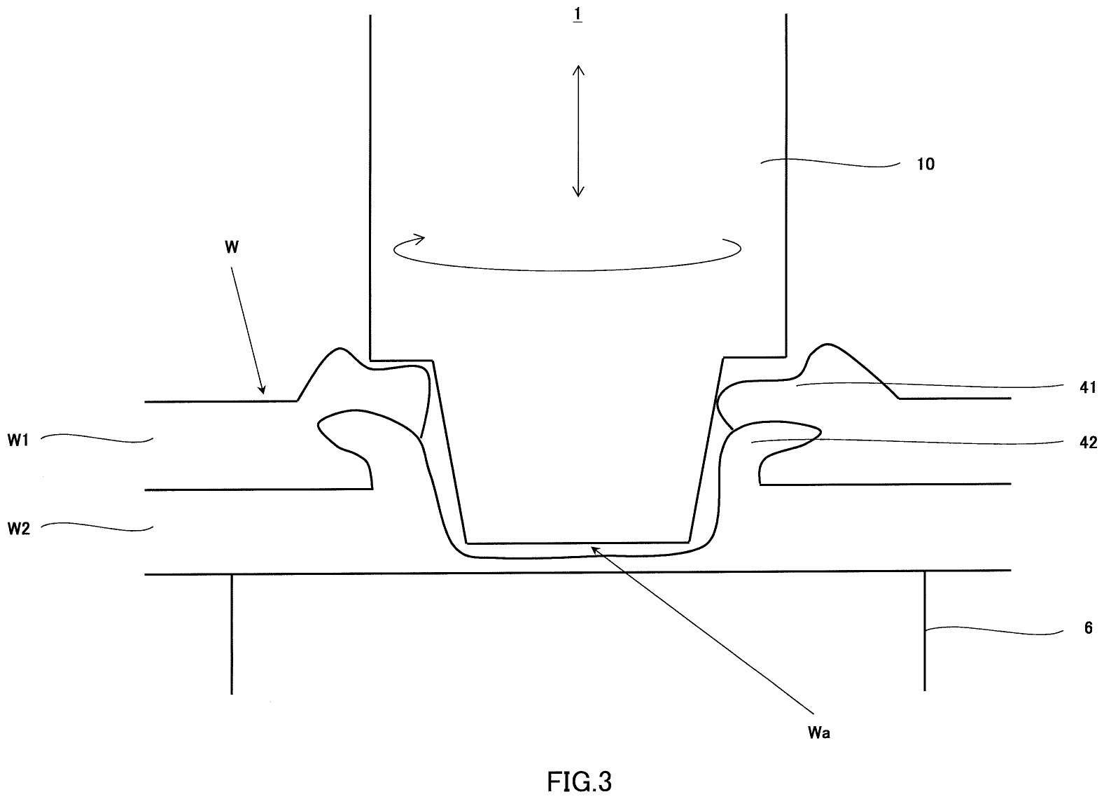

FIG. 2 is a flowchart illustrating one example of operation of the friction welding apparatus according to Embodiment 1. FIG. 3 is a schematic view illustrating a substantial part of the friction welding apparatus according to Embodiment 1, and illustrates a state where a friction welding is performed.

The operator first places the to-be-joined object W on an upper surface of the support 6. Next, the operator operates an input device (not illustrated) to input a joining execution of the to-be-joined object W into the control device 30.

Then, as illustrated in FIG. 2, the control device 30 drives the rotary driver 8 to rotate the tool holder 4 and the tool 10 at a given rotational speed (e.g., 500 to 3000 rpm) (Step S101). Next, the control device 30 drives the linear driver 7 so that the tip-end part of the tool 10 moves to a given first position set beforehand, while rotating the tool holder 4 and the tool 10 (Step S102). At this time, the control device 30 controls the linear driver 7 so that the tool 10 is pressed against the to-be-joined object W with a given pressing force set beforehand (e.g., 4 kN to 70 kN). Note that the given rotational speed and the given pressing force may suitably be set beforehand by an experiment etc. Note that the first position will be described later.

Therefore, the tool 10 contacts the to-be-joined part Wa of the to-be-joined object W, and frictional heat is generated by friction of the tip-end part of the tool 10 with the to-be-joined part Wa so that the to-be-joined part Wa of the to-be-joined object W is softened, and a plastic flow occurs.

Then, as illustrated in FIG. 3, by pressing the tip-end part of the tool 10 into the to-be-joined part Wa, a second softened part 42 which is a softened part of the second member W2 enters (sticks) into a first softened part 41 which is a softened part of the first member W1. Note that, herein, the second softened part 42 which enters into the first softened part 41 is referred to as an “anchoring part.”

Next, the control device 30 acquires the temperature of the to-be-joined part Wa of the to-be-joined object W detected by the temperature detector 60 (Step S103). Then, the control device 30 determines whether the temperature acquired at Step S103 is at or above an A1 transformation point (Step S104).

Note that, although in Embodiment 1 the control device 30 determines whether the temperature acquired at Step S103 is at or above the A1 transformation point, it is not limited to this configuration. In terms of further increasing the joining strength of the to-be-joined object W, the control device 30 may determine whether the temperature acquired at Step S103 is above the A1 transformation point, or may determine whether the temperature acquired at Step S103 is at or above an A3 transformation point.

If the temperature of the to-be-joined part Wa becomes at or above the A1 transformation point, the second softened part 42 can be transformed into martensite when the tool 10 is drawn out. Therefore, the strength of the second softened part 42 which is the anchoring part can be increased, and therefore, the tensile strength of the to-be-joined object W can be increased.

Moreover, if the temperature of the to-be-joined part Wa becomes at or above the A3 transformation point, a ratio of the second softened part 42 transformed into martensite can be increased. Therefore, the strength of the second softened part 42 which is the anchoring part is further increased, and therefore, the tensile strength of the to-be-joined object W can be increased.

If the temperature acquired at Step S103 is determined to be below the A1 transformation point (No at Step S104), the control device 30 controls the rotary driver 8 and/or the linear driver 7 so that the rotational speed and/or the pressing force of the tool 10 increase (Step S105), and repeats the processing at Steps S103 to S105 until the temperature of the to-be-joined part Wa of the to-be-joined object W becomes at or above the A1 transformation point.

On the other hand, if the temperature acquired at Step S103 is determined to be at or above the A1 transformation point (Yes at Step S104), the control device 30 executes the processing at Step S106.

At Step S106, the control device 30 determines whether the tip-end part of the tool 10 reaches the first position. Note that the positional information on the tip-end part of the tool 10 is detected by a position detector (not illustrated), and is outputted to the control device 30.

Here, the first position is set arbitrarily within a rage larger than 0% and less than 100%, when a surface of the second member W2 which contacts the first member W1 is set as 0%, and a surface of the second member W2 which contacts the support 6 is set as 100%. Note that, in terms of increasing the joining strength, the first position is preferably closer to the surface of the second member W2 which contacts the support 6, may be 25% or more, may be 50% or more, may be 75% or more, may be 80% or more, may be 90% or more, or may be 95% or more.

If the control device 30 determines that the tip-end part of the tool 10 does not reach the first position (No at Step S106), it then executes the processing at Steps S103 to S106 until the tip-end part of the tool 10 reaches the first position. On the other hand, if the control device 30 determines that the tip-end part of the tool 10 reaches the first position (Yes at Step S106), it then executes the processing at Step S107.

At Step S107, the control device 30 drives the linear driver 7 so that the tip-end part of the tool 10 is drawn out from the to-be-joined part Wa while the tool holder 4 and the tool 10 are rotated. Then, when the tip-end part of the tool 10 is drawn out from the to-be-joined part Wa, the control device 30 suspends the rotary driver 8 so that the rotation of the tool holder 4 and the tool 10 are suspended, and then ends this program. Note that, when joining a plurality of to-be-joined parts Wa, the control device 30 may start a joining of the next to-be-joined part Wa, without suspending the rotation of the tool holder 4 and the tool 10.

With the friction welding apparatus 1 according to Embodiment 1 configured in this way, an anchoring effect is acquired in which the second softened part 42 of the second member W2 enters into the first softened part 41 of the first member W1 by performing the friction welding to the to-be-joined object W, and thus, a tensile-shear strength increases and a peel strength also relatively increases.

Moreover, with the friction welding apparatus 1 according to Embodiment 1, the control device 30 controls the linear driver 7 and the rotary driver 8 so that the temperature of the to-be-joined part Wa becomes at or above the A1 transformation point. Therefore, the second part 42 of the second member W2 becomes in a so-called “heat-treated (hardened) state,” and the strength of the anchoring part (the second softened part 42) is increased. Thus, the tensile-shear strength further increases, and therefore, the anchoring effect is further increased.

### Modification 1

Next, a modification of the friction welding apparatus according to Embodiment 1 is described.

A friction welding apparatus in Modification 1 is the friction welding apparatus according to Embodiment 1, where the first member is comprised of a plurality of first sub members.

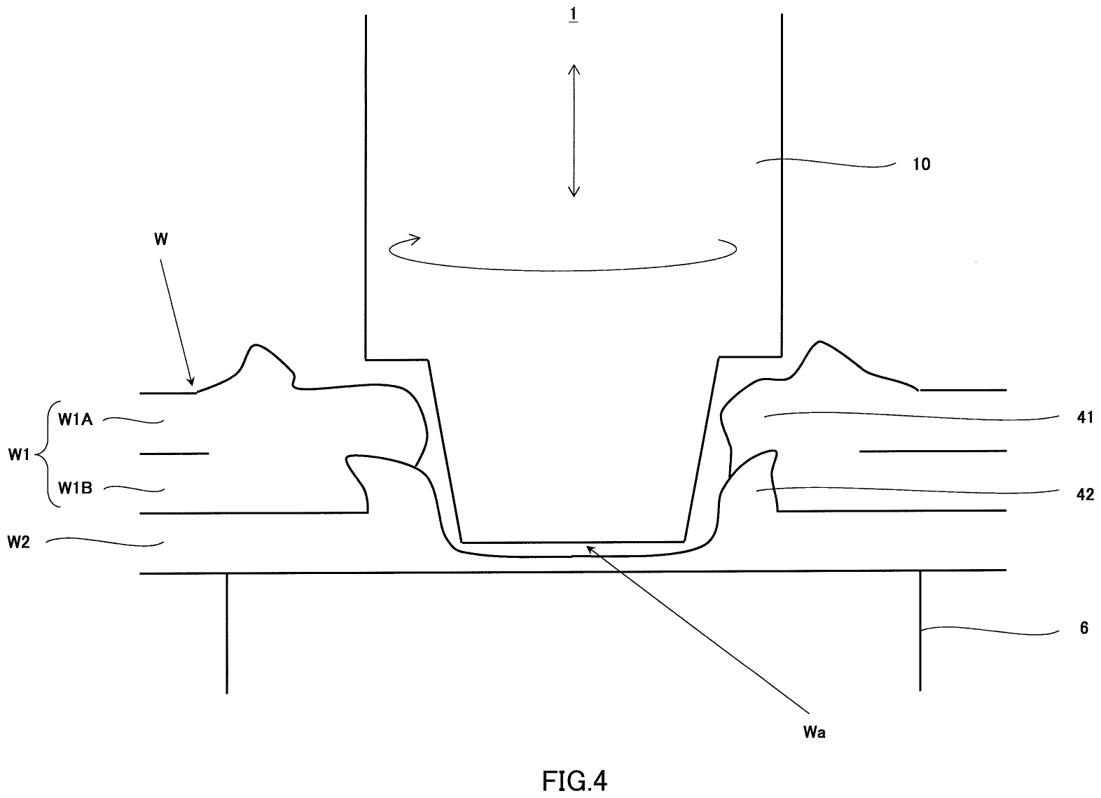

Below, the friction welding apparatus in Modification 1 is described with reference to FIG. 4.

FIG. 4 is a schematic view illustrating a substantial part of one example of the friction welding apparatus in Modification 1, and illustrates a state where the friction welding is performed.

As illustrated in FIG. 4, the friction welding apparatus 1 in Modification 1 has fundamentally the same configuration as the friction welding apparatus 1 according to Embodiment 1, but it differs in that the first member W1 is comprised of a plurality of first sub members W1A and W1B. In the plurality of first sub members, at least one of the first sub members may be made of a different type of material from the second member W2.

For example, the second member W2 may be made of steel, and the first sub members W1A and W1B may be made of aluminum. In this case, as illustrated in FIG. 4, the first sub members W1A and W1B are softened by the friction with the tip-end part of the tool 10, and the softened part is agitated and joined. Therefore, the second softened part 42 of the second member W2 enters (sticks) into the part (the first softened part 41) where the first sub members W1A and W1B are softened, agitated, and joined.

The friction welding apparatus 1 in Modification 1 configured in this way also has similar operation and effects to the friction welding apparatus 1 according to Embodiment 1.

### Modification 2

A friction welding apparatus in Modification 2 is the friction welding apparatus according to Embodiment 1 (including the friction welding apparatus in Modification 1), where the second member is comprised of a plurality of second sub members.

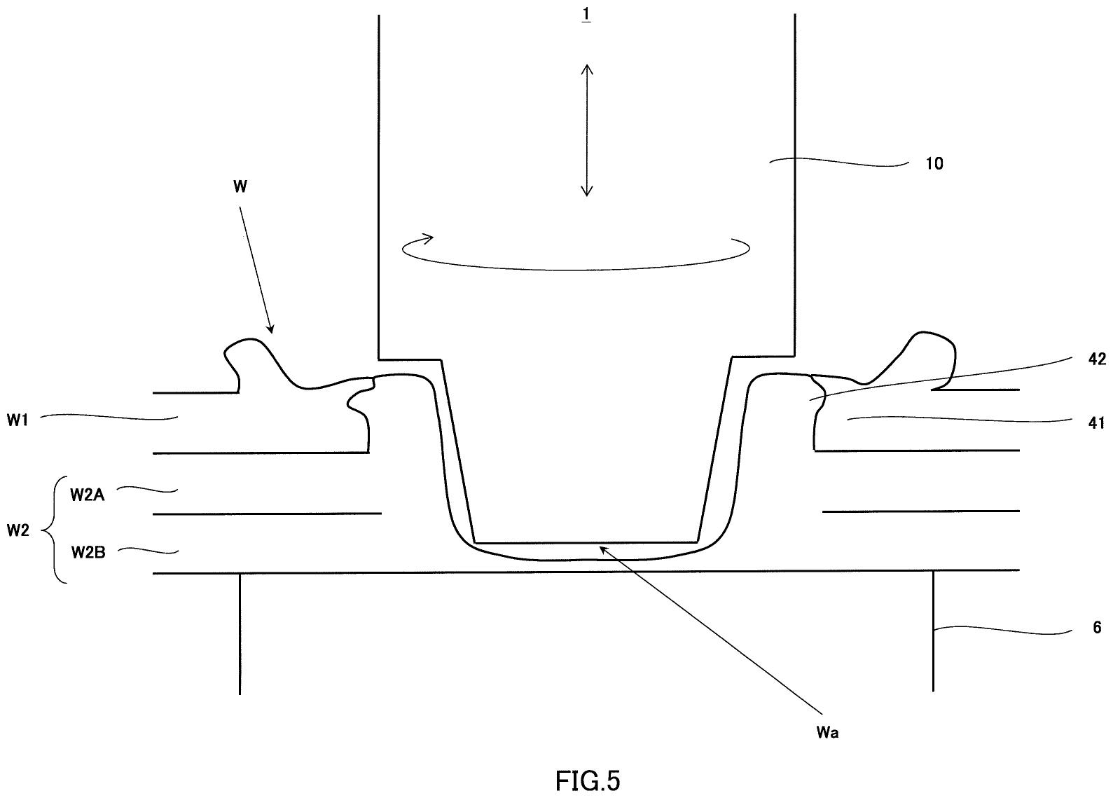

Below, the friction welding apparatus in Modification 2 is described with reference to FIG. 5.

FIG. 5 is a schematic view illustrating a substantial part of one example of the friction welding apparatus in Modification 2, and illustrates a state where the friction welding is performed.

As illustrated in FIG. 5, the friction welding apparatus 1 in Modification 2 has fundamentally the same configuration as the friction welding apparatus 1 according to Embodiment 1, but it differs in that the second member W2 is comprised of a plurality of second sub members W2A and W2B. In the plurality of second sub members, at least one of the second sub members may be made of a different type of material from the first member W1.

For example, the second sub members W2A and W2B may be made of steel, and the first member W1 may be made of aluminum. In this case, as illustrated in FIG. 5, the second sub members W2A and W2B are softened by the friction with the tip-end part of the tool 10, and the softened part is agitated and joined. Therefore, the part of the second sub members W2A and W2B which is softened, agitated, and joined (the second softened part 42) enters (sticks) into the first softened part 41.

The friction welding apparatus 1 in Modification 2 configured in this way also has similar operation and effects to the friction welding apparatus 1 according to Embodiment 1.

### Embodiment 2

A friction welding apparatus according to Embodiment 2 is additionally provided with a storage device which stores first data indicative of a correlation between the temperature of the to-be-joined part, and the pressing force and the rotational speed of the tool to the friction welding apparatus according to Embodiment 1 (including Modifications 1 and 2).

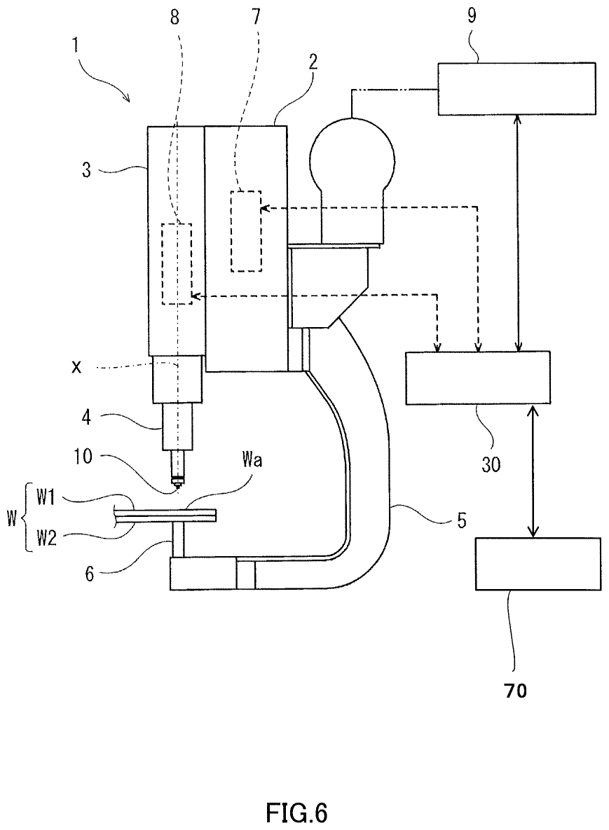

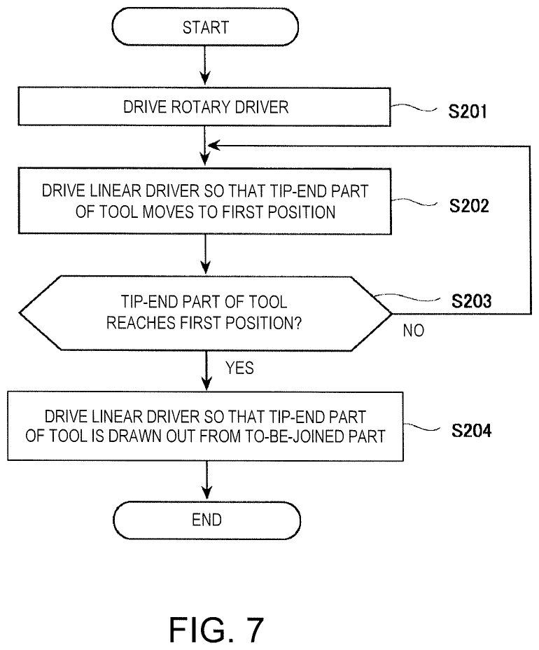

Below, one example of the friction welding apparatus according to Embodiment 2 is described with reference to FIGS. 6 and 7.

### Configuration of Friction Welding Apparatus

FIG. 6 is a schematic view illustrating an outline configuration of the friction welding apparatus according to Embodiment 2.

As illustrated in FIG. 6, the friction welding apparatus 1 according to Embodiment 2 has fundamentally the same configuration as the friction welding apparatus 1 according to Embodiment 1, but it differs in that it is provided with a storage device 70, instead of the temperature detector 60.

The storage device 70 stores the first data indicative of the correlation between the temperature of the to-be-joined part Wa, and the pressing force and the rotational speed of the tool 10. The first data may suitably be set beforehand by an experiment etc. In detail, for example, similar to the friction welding apparatus 1 according to Embodiment 1, the temperature of the to-be-joined part Wa is detected by the temperature detector 60, the pressing force and the rotational speed of the tool 10 (a driving amount of the linear driver 7 and a driving amount of the rotary driver 8) when the temperature is detected are acquired, and these information is stored as a database, to obtain the first data.

The storage device 70 may be comprised of a memory (not illustrated) which constitutes the control device 30, or may be comprised of various kinds of storage media, such as an external hard disk or a USB memory.

### Operation of Friction Welding Apparatus (Method of Operating Friction Welding Apparatus)

Next, operation of the friction welding apparatus 1 according to Embodiment 2 is described with reference to FIGS. 6 and 7.

FIG. 7 is a flowchart illustrating one example of operation of the friction welding apparatus according to Embodiment 2.

The operator first places the to-be-joined object W on the upper surface of the support 6. Next, the operator operates the input device (not illustrated) to input the joining execution of the to-be-joined object W into the control device 30.

Then, as illustrated in FIG. 7, the control device 30 drives the rotary driver 8 to rotate the tool holder 4 and the tool 10 at a given rotational speed (e.g., 500 to 3000 rpm) (Step S201). Next, the control device 30 drives the linear driver 7 so that the tip-end part of the tool 10 moves to the first position, while rotating the tool holder 4 and the tool 10 (Step S202). At this time, the control device 30 controls the linear driver 7 so that the tool 10 is pressed against the to-be-joined object W with a given pressing force set beforehand (e.g., 4 kN to 70 kN). Note that the given rotational speed and the given pressing force are suitably set by the control device 30 reading the first data stored in the storage device 70.

Next, the control device 30 determines whether the tip-end part of the tool 10 reaches the first position (Step S203). Note that the positional information on the tip-end part of the tool 10 is detected by the position detector (not illustrated), and is outputted to the control device 30.

If the control device 30 determines that the tip-end part of the tool 10 does not reach the first position (No at Step S203), it then executes the processing at Steps S202 and S203 until the tip-end part of the tool 10 reaches the first position. On the other hand, if the control device 30 determines that the tip-end part of the tool 10 reaches the first position (Yes at Step S203), it then executes the processing at Step S204.

At Step S204, the control device 30 drives the linear driver 7 so that the tip-end part of the tool 10 is drawn out from the to-be-joined part Wa, while rotating the tool holder 4 and the tool 10. Then, when the tip-end part of the tool 10 is drawn out from the to-be-joined part Wa, the control device 30 suspends the rotary driver 8 so that the rotation of the tool holder 4 and the tool 10 is suspended, and ends this program. Note that, when joining the plurality of to-be-joined parts Wa, the control device 30 may start the joining of the next to-be-joined part Wa, without suspending the rotation of the tool holder 4 and the tool 10.

The friction welding apparatus 1 according to Embodiment 2 configured in this way also has similar operation and effects to the friction welding apparatus 1 according to Embodiment 1.

It is apparent for the person skilled in the art that many improvements or other embodiments of the present disclosure are possible from the above description. Therefore, the above description is to be interpreted only as illustration, and it is provided in order to teach the person skilled in the art the best mode that implements the present disclosure. The details of the configurations and/or the functions may be changed substantially, without departing from the spirit of the present disclosure. Moreover, various inventions may be formed by suitable combinations of the plurality of components disclosed in the above embodiments.

### INDUSTRIAL APPLICABILITY

The friction welding apparatus and the method of operating the same of the present disclosure are useful because they can increase the joining strength even if the plurality of members made of different materials are joined using frictional heat.

### DESCRIPTION OF REFERENCE CHARACTERS

1 Friction Welding Apparatus

2 Base Body

3 Movable Body

4 Tool Holder

5 Curved Frame

6 Support

7 Linear Driver

8 Rotary Driver

9 Robotic Arm

10 Tool

30 Control Device

41 First Softened Part

42 Second Softened Part

60 Temperature Detector

70 Storage Device

W To-be-joined Object

W1 First Member

W1A First Sub Member

W1B First Sub Member

W2 Second Member

W2A Second Sub Member

W2B Second Sub Member

Wa To-be-joined Part

X Axis

1. A friction welding apparatus configured to join a to-be-joined object having a first member and a second member by softening with frictional heat, comprising:
a tool formed cylindrically, and rotatable about an axis thereof and reciprocatable in a direction along the axis;
a rotary driver configured to rotate the tool about the axis;
a linear driver configured to reciprocate the tool along the axis; and
a control device,
wherein the first member is disposed opposing to the tool and is made of a different type of material from the second member, and the second member is made of steel, and
wherein the control device controls the linear driver and the rotary driver so that:
(A) the tool is rotated about the axis while a tip-end part of the tool is pressed against a to-be-joined part of the to-be-joined object to increase a temperature of the to-be-joined part at or above an A1 transformation point;
(B) while the temperature of the to-be-joined part is maintained at or above the A1 transformation point, the tip-end part of the tool reaches a given first position set beforehand so that the softened second member sticks into the softened first member; and
(C) the tool is drawn out from the to-be-joined part, while the temperature of the to-be-joined part is maintained at or above the A1 transformation point and the tool is rotated.

2. The friction welding apparatus of claim 1, wherein, during (A), the control device controls the linear driver and the rotary driver so that the temperature of the to-be-joined part becomes at or above an A3 transformation point.

3. The friction welding apparatus of claim 1, wherein, during (B), the control device controls the linear driver and the rotary driver so that the temperature of the to-be-joined part is maintained at or above an A3 transformation point.

4. The friction welding apparatus of claim 1, wherein, during (C), the control device controls the linear driver and the rotary driver so that the temperature of the to-be-joined part is maintained at or above an A3 transformation point.

5. The friction welding apparatus of claim 1, wherein the first member is made of at least one of materials including aluminum, thermoplastic resin, and fiber-reinforced plastic.

6. The friction welding apparatus of claim 1, wherein the first member is comprised of a plurality of first sub members.

7. The friction welding apparatus of claim 1, wherein the second member is comprised of a plurality of second sub members.

8. The friction welding apparatus of claim 1, further comprising a temperature detector configured to detect the temperature of the to-be-joined part,
wherein the control device determines whether the temperature of the to-be-joined part is at or above the A1 transformation point based on the temperature detected by the temperature detector.

9. The friction welding apparatus of claim 1, further comprising a storage device storing first data indicative of a correlation between the temperature of the to-be-joined part, and a pressing force and a rotational speed of the tool.

10. A method of operating a friction welding apparatus configured to join a to-be-joined object having a first member and a second member by softening with frictional heat, the apparatus comprising:
a tool formed cylindrically, and rotatable about an axis thereof and reciprocatable in a direction along the axis;
a rotary driver configured to rotate the tool about the axis; and
a linear driver configured to reciprocate the tool along the axis,
wherein the first member is disposed opposing to the tool and is made of a different type of material from the second member, and the second member is made of steel,
the method comprising the steps of:
operating the linear driver and the rotary driver so that:
(A) the tool is rotated about the axis while a tip-end part of the tool is pressed against a to-be-joined part of the to-be-joined object to increase a temperature of the to-be-joined part at or above an A1 transformation point;
(B) while the temperature of the to-be-joined part is maintained at or above the A1 transformation point, the tip-end part of the tool reaches a given first position set beforehand so that the softened second member sticks into the softened first member; and
(C) the tool is drawn out from the to-be-joined part, while the temperature of the to-be-joined part is maintained at or above the A1 transformation point and the tool is rotated.

11. The method of claim 10, wherein, during (A), the linear driver and the rotary driver are operated so that the temperature of the to-be-joined part becomes at or above an A3 transformation point.

12. The method of claim 10, wherein, during (B), the linear driver and the rotary driver are operated so that the temperature of the to-be-joined part becomes at or above an A3 transformation point.

13. The method of claim 1, wherein, during (C), the linear driver and the rotary driver are operated so that the temperature of the to-be-joined part becomes at or above an A3 transformation point.

14. The method of claim 1, wherein the first member is made of at least one of materials including aluminum, thermoplastic resin, and fiber-reinforced plastic.

15. The method of claim 1, wherein the first member is comprised of a plurality of first sub members.

16. The method of claim 1, wherein the second member is comprised of a plurality of second sub members.

17. The method of claim 1, wherein the friction welding apparatus further comprises a temperature detector configured to detect the temperature of the to-be-joined part, and
wherein, during (A) to (C), the linear driver and the rotary driver are operated so that the temperature detected by the temperature detector becomes at or above the A1 transformation point.

18. The method of claim 1, wherein the friction welding apparatus further comprises a storage device storing first data indicative of a correlation between the temperature of the to-be-joined part, and a pressing force of the linear driver and a rotational speed of the rotary driver, and
wherein, during (A) to (C), the linear driver and the rotary driver are operated based on the first data.
